(19) United States
(12) Patent Application Publication
(10) Pub. No.: US 2022/0026338 A1
(43) Pub. Date: Jan. 27, 2022

(54) METHOD FOR DETECTING PARTICLES OR AEROSOL IN A FLOWING FLUID, COMPUTER PROGRAM, AS WELL AS ELECTRICAL MEMORY MEDIUM

(71) Applicant: Robert Bosch GmbH, Stuttgart (DE)

(72) Inventor: Radoslav Rusanov, Stuttgart (DE)

(21) Appl. No.: 17/312,053

(22) PCT Filed: Oct. 23, 2019
(86) PCT No.: PCT/EP2019/078907

§ 371 Date: Jun. 9, 2021

(30) Foreign Application Priority Data
Dec. 13, 2018 (DE) 102018221700.9

(51) Int. Cl. G01N 15/14; G01M 15/10

(52) U.S. Cl. CPC G01N 15/1434; G01M 15/108; G01N 2015/0046; G01N 2015/1493; G01N 2015/1486

(57) ABSTRACT

A method for detecting particles or aerosol in a flowing fluid, using the principle of laser-induced incandescence. The method includes the following steps: a. focusing a laser light originating from a laser in a spot; b. conducting a fluid which includes particles or aerosol through the spot; c. detecting a thermal radiation originating from the spot with the aid of a detector; and d. evaluating a variable which is provided by the detector and characterizes the detected thermal radiation within time intervals, the duration of the time intervals being dependent on a velocity of the fluid.

### FIELD

The present invention relates to a method for detecting particles or aerosol in a flowing fluid, using the principle of laser-induced incandescence, as well as to a computer program and to an electrical memory medium.

### BACKGROUND INFORMATION

The principle of laser-induced incandescence (“LII”) has already been used for quite some time for the detection of nanoparticles in a gas, for example in air, and is also intensively applied, e.g., for the characterization of the combustion process in “vitreous” engines in the laboratory or for the exhaust gas characterization in laboratory surroundings. In the process, the particles, for example soot particles, are heated to several thousand degrees Celsius using a nanosecond pulse of a high-power laser, so that they emit significant heat or thermal radiation. This thermally induced light emission of the particles is measured with the aid of a light detector. The differentiation of signals of small particles from so-called “background signals” caused by thermal effects and/or signal noise represents a challenge in the process.

### SUMMARY

An object of the present invention may be achieved by a method as well as by a computer program and an electrical memory medium having the features of the present invention.

Advantageous refinements of the present invention are disclosed herein.

The method according to the present invention is used for detecting particles or aerosol in a fluid, for example an exhaust gas. It operates using the principle of laser-induced incandescence (LII). In accordance with an example embodiment of the present invention, in the process, initially, using laser light which originates from a laser and is focused in a spot, i.e., a volume area having the smallest dimensions in the μm range, with sufficiently high intensity, a particle is heated to several thousand degrees through partial absorption of the laser light. According to Planck's radiation law, this hot particle gives off a characteristic thermal radiation (incandescence or thermionic emission), which serves as a measuring signal and is received with the aid of a detector. The spectrum of this thermally emitted light (thermal radiation) usually has a relatively broadband design, having a maximum in the red range (at approximately 750 nm).

An optical element which is situated in the beam path of the laser is used for this purpose, which is designed and configured to focus the laser light originating from the laser in the very small spot. In the case of a focus diameter of, e.g., 10 μm, it may be assumed that only one particle passes through the spot at any given point in time (intrinsic individual particle detectability), when using a particle concentration of 10¹³/m³ as a basis. The detector is configured and situated in such a way that it detects the thermal radiation originating from the spot. Cost-effective semiconductor laser diodes may be used as the laser. The detection of the thermal radiation may, e.g., take place with the aid of a sensitive photodiode or a multi-pixel photon counter (MPPC).

Specifically, the method according to an example embodiment of the present invention includes at least the following steps:

a. focusing a laser light originating from a laser in a spot;

b. conducting a fluid which includes particles or aerosol through the spot;

c. detecting a thermal radiation originating from the spot with the aid of a detector; and

d. evaluating a variable which is provided by the detector and characterizes the detected thermal radiation within time intervals, the duration of the time intervals being dependent on a velocity of the fluid.

In the process, the present invention takes advantage of the fact that the particles or aerosols have a typical passage time through the laser spot which depends on known and constant spot dimensions and, above all, on the variable velocity of the fluid in which the particles are or the aerosol is present. In this way, it is possible to predict the likely duration during which the signal provided by the detector changes based on a detected thermal radiation. In this way, the signal evaluation may be limited to this duration so that “background signal noise” present before and thereafter may be suppressed and thus has a lesser influence.

The present invention is thus directed to a method for the expanded signal evaluation, in which the information regarding the fluid velocity (e.g., from an engine control unit of an internal combustion engine) is used to control a time interval (particle detection interval), within which the variable characterizing the detected thermal radiation (for example, intensity over the time) is evaluated, as a function of a velocity of the fluid, and thus to optimize the signal-to-noise ratio. In the process, the time interval is shorter at a high velocity of the fluid than at a low velocity of the fluid.

The method according to an example embodiment of the present invention allows both a measurement of the number and the mass concentration of particles or aerosols in a flowing fluid, in particular, of soot particles in the exhaust gas of diesel and gasoline vehicles. This explicitly includes the capability for individual particle detection in a test volume, so that the particle size may also be determined from the measured data. The method according to the present invention may be used for the on-board diagnostic (OBD) monitoring of the condition of a particulate filter. A particle sensor operated using the method according to the present invention has a short response time and is essentially immediately ready for use after activation.

Measurability of particle count as well as an immediate readiness for use immediately after the start of the vehicle are very important, especially in gasoline vehicles, since a majority of the very fine particles (low mass, high count) typically emitted in motor vehicles including a gasoline internal combustion engine arises during the cold start.

The present invention allows an improvement or optimization of the relationship between the actual signal and a signal noise so that even very small soot particles may be reliably detected. In particular, a lower detection limit may be reduced by the method according to the present invention, for example to a particle size of less than 23 nm. Finally, simplified evaluation algorithms may be used thanks to the method according to the present invention, by which a computing time is reduced.

In one refinement of the present invention, it is provided that at least some time intervals overlap. This allows a seamless evaluation of the variable characterizing the detected thermal radiation. The time intervals may thus be a kind of “sliding window,” i.e., that the variable provided by the detector is evaluated during a time interval and compared to the expected background noise, this time interval being “pushed” forward, e.g., in a certain time pattern, for example every 1 μs, so that always the temporally last sections of the variable in the time interval are evaluated.

In one refinement of the present invention, it is provided that the duration of the time interval is greater than an expected FWHM of the variable characterizing the thermal radiation, in particular, approximately 1 to 2 times, more preferably approximately 1.5 times the expected FWHM. An FWHM shall be understood to mean a “full width at half maximum” which is the difference between the two argument values for which the function values have dropped to half the maximum. In this way, the option is created to evaluate the entire relevant range of the curve of a variable characterizing the detected thermal radiation in the case of a detected particle.

In this way, the duration of the time interval during which the variable provided by the detector is compared to the expected background and a decision is made as to the detection or non-detection of a particle is adapted to the expected FWHM of the variable provided by the detector which is ascertained based on the velocity of the fluid. This may, e.g., be one or two times the expected FWHM. These adaptations of the duration of the time interval or “evaluation window” are used to not unnecessarily collect background noise around the signal expected in the case of a detected particle, by which the signal-to-noise ratio would worsen.

In one refinement of the present invention, it is provided that an overlapping time period of two adjoining or consecutive time intervals corresponds to at least half the duration of the time interval. This allows a reliable evaluation of the entire curve of the variable provided by the detector.

In one refinement of the present invention, it is provided that a particle is considered to be detected when the variable characterizing the thermal radiation or ascertained therefrom at least reaches a limiting value within a time interval. This is easy to implement from a programming point of view.

The limiting value may depend on an expected background noise. In this way, the “sensitivity” may be adapted to the expected background noise.

In one refinement of the present invention, it is provided that at least some consecutive time intervals do not overlap, however preferably directly follow one another. This is also very easy to implement from a programming point of view. The variable characterizing the thermal radiation is thus “collected” in temporally fixed intervals which, by way of example, may have a duration of, e.g., 0.5 times the FWHM.

In one refinement of the present invention, it is provided that a particle is considered to be detected when the variable characterizing the thermal radiation or ascertained therefrom at least reaches one limiting value, or multiple different limiting values, within at least two time intervals directly following one another. In this way, the detection of a particle may be indicated in a very simple manner. In the process, the limiting value(s) may again depend on an expected background noise.

In one refinement of the present invention, it is provided that the variable characterizing the thermal radiation is a continuous variable, and preferably an integral is formed from it within the scope of the evaluation within the time interval. This is well-suited, for example, when the detector is a photodiode.

In one refinement of the present invention, it is provided that the variable characterizing the thermal radiation encompasses a discontinuous variable, in particular, a number of pulse-like signals. This is well-suited when the detector is an MPPC. Within the scope of the evaluation, it is then possible to ascertain a number of the pulse-like signals therefrom within a time interval.

It shall be understood that the above-mentioned types of time intervals (overlapping/non-overlapping) may also be combined with one another, i.e., may be implemented as mixed forms.

In one refinement of the present invention, it is provided that the velocity of the fluid is ascertained from an FWHM of preferably large particles, and that this ascertained velocity is then used to determine the length of the time intervals for the detection of the small particles. In the case of large particles, the signal-to-noise ratio (SNR) is particularly favorable.

The present invention also relates to a computer program which is programmed to execute the example methods disclosed herein, as well as to an electrical memory medium for an evaluation unit, in particular, for use in an exhaust gas system of an internal combustion engine, on which a computer program for executing the above method is stored, and finally also to a state machine, in particular, an ASIC, which is programmed to execute the above method.

Specific example embodiments of the present invention are described hereafter with reference to the figures.

### BRIEF DESCRIPTION OF THE DRAWINGS

FIG. 1 shows a measuring principle based on the laser-induced incandescence, which is used in the present invention using a detector, by way of example in the form of a photodiode.

FIG. 2 shows a basic design of a particle sensor which employs the measuring principle schematically illustrated in FIG. 1, in accordance with the present invention.

FIG. 3 shows a block diagram for explaining the configuration of the particle sensor of FIG. 2 in accordance with the present invention.

FIG. 4 shows a detailed representation of the configuration of the particle sensor of FIG. 3, including the representation of a flowing fluid in which particles are present.

FIG. 5 shows a diagram in which the curve of a variable which is provided by the detector of the particle sensor of FIG. 4 and characterizes a detected thermal radiation is represented over the time, together with a first type of evaluation time intervals, at a first velocity of the flowing fluid.

FIG. 6 shows a diagram similar to FIG. 5, at a second velocity of the flowing fluid which is higher than the first velocity.

FIG. 7 shows a diagram similar to FIG. 5, using a second type of evaluation time intervals at a first velocity of the flowing fluid.

FIG. 8 shows a diagram similar to FIG. 7, at a second velocity of the flowing fluid which is higher than the first velocity.

FIG. 9 shows a diagram similar to FIG. 5, however using a different type of variable provided by the detector.

FIG. 10 shows a flowchart of a method for detecting particles, in accordance with an example embodiment of the present invention.

Functionally equivalent elements and areas bear the same reference numerals in the following description.

### DETAILED DESCRIPTION OF EXAMPLE EMBODIMENTS

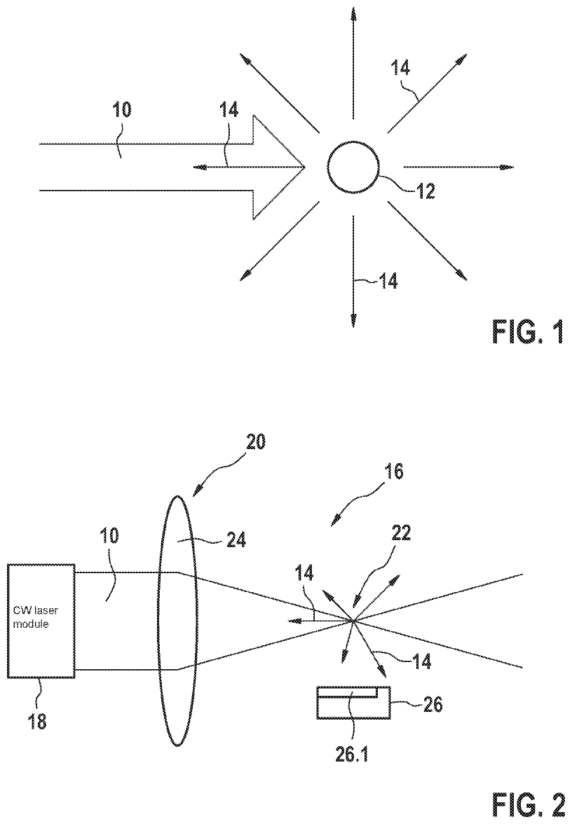

FIG. 1 illustrates the measuring principle based on laser-induced incandescence (“LII”). Laser light 10 of high intensity impinges on a particle 12, for example a soot particle in the exhaust gas flow of an internal combustion engine (not shown). The intensity of laser light 10 is so high that the energy of laser light 10 absorbed by particle 12 heats particle 12 to several thousand degrees Celsius. As a result of the heating, particle 12, spontaneously and essentially without a preferred direction, emits significant radiation 14 in the form of thermal radiation, also referred to as LII light. A portion of radiation 14 emitted in the form of thermal radiation is thus also emitted opposite the direction of the incident laser light 10.

FIG. 2 schematically shows a basic design of one exemplary embodiment of a particle sensor 16. Particle sensor 16 here includes a continuous wave (CW) laser module 18, whose preferably parallel laser light 10 is focused onto a very small spot 22 using at least one optical element 20 situated in the beam path of CW laser module 18. Spot here shall be understood to mean a volume element having very small dimensions in the μm range. Optical element 20 preferably includes a lens 24. The intensity of laser light 10 only reaches the high values necessary for laser-induced incandescence in the volume of spot 22.

The dimensions of spot 22 are in the range of several μm, in particular, in the range of no more than 200 μm, so that particles 12 passing through spot 22 are excited to emit evaluatable radiation outputs, be it by laser-induced incandescence or by chemical reactions (in particular, oxidation). As a result, it may be assumed that no more than one particle 12 at a time is present in spot 22, and that an instantaneous measuring signal of particle sensor 16 only stems from this no more than one particle 12.

The measuring signal is generated by a detector 26 which is situated in particle sensor 16 in such a way that it detects radiation 14, in particular, thermal radiation, originating from particle 12 passing through spot 22. In this respect, the measuring signal provided by detector 26 is a variable characterizing the detected thermal radiation. For this purpose, detector 26 preferably includes at least one photodiode 26.1 which detects the thermal radiation and enables a quantification (intensity as a function of the time). In this way, an individual particle measurement becomes possible, which allows pieces of information about particle 12, such as size and velocity, to be extracted. For example, a cost-effective silicon photomultiplier (SiPM) or a single-photon avalanche diode (SPAD diode) is possible as photodiode 26.1.

As an alternative, the detector may also include a multi-pixel photon counter (MPPC).

As a result, it is already possible to detect a light signal which is generated by a particularly small particle and thus is extremely small, which is formed by a few 10 photons, for example. In this way, the dimensions of particles which are just barely still detectable decreases to a lower detection limit of up to 10 nm.

It is quite possible that the laser of laser module 18 is modulated or switched on and off (duty cycle <100%). However, it remains preferred that the laser of laser module 18 is a CW laser. This allows the use of cost-effective semiconductor laser elements (laser diodes), which reduces the cost of the entire particle sensor 16 and drastically simplifies the activation of laser module 18 and the evaluation of the measuring signal. However, the use of pulsed lasers is not precluded.

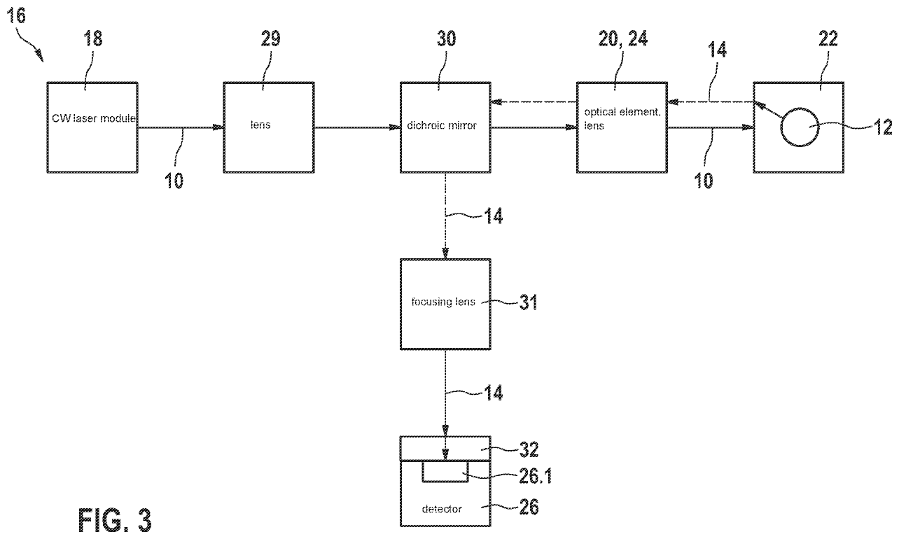

FIG. 3 shows a block diagram of one possible specific embodiment of particle sensor 16. Initially, laser module 18 which emits laser light 10 is apparent. Laser light 10 is initially formed by a lens 29 into a parallel beam, which passes through a beam splitting device, for example a beam splitter or a dichroic mirror 30. From there, it reaches optical element 20 or lens 24 and thereafter, in focused form, spot 22.

Thermal radiation 14 (dotted arrows) of a particle 12 excited in spot 22 by laser light 10, in turn, reaches dichroic mirror 30 again through lens 24, where it is deflected, in the present example by way of example by 90°, passes through a focusing lens 31 and, through a filter 32 (which is not necessarily present), reaches photodiode 26.1 of detector 26 (it is also possible that the thermal radiation first passes through a filter, and then through a focusing lens). Filter 32 is designed in such a way that it filters out the wavelengths of laser light 10. The interfering background is thus reduced by filter 32. The exemplary embodiment including filter 32 specifically takes advantage of the narrow bandwidth of laser sources (e.g., laser diodes) by filtering out precisely this narrow bandwidth upstream from detector 26. The use of a simple edge filter is also possible. As a result, the signal-to-noise ratio improves.

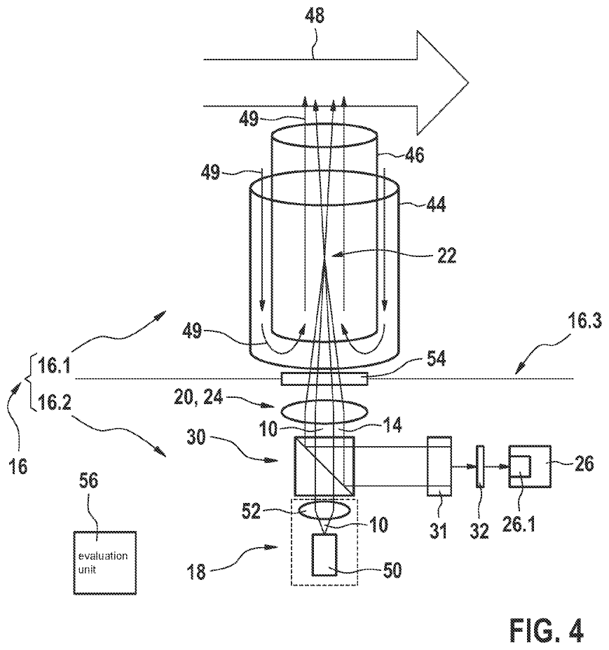

FIG. 4 shows one advantageous exemplary embodiment of a particle sensor 16 in greater detail, which is suitable for the use as a soot particle sensor in the exhaust gas of a combustion process, for example in the exhaust gas system of an internal combustion engine. The exhaust gas in this respect forms an example of a fluid which flows at a certain velocity and includes particles.

Particle sensor 16 includes a system made up of an outer protective tube 44 and an inner protective tube 46. The two protective tubes 44, 46 preferably have a general cylinder shape or prism shape. The base areas of the cylinder shapes are preferably circular, elliptic, or polygonal. The cylinders are preferably coaxially situated, the axes of the cylinders being aligned transversely to the flow of exhaust gas 48. Inner protective tube 46 protrudes in the direction of the axes beyond outer protective tube 44 into flowing exhaust gas 48. At the end of the two protective tubes 44, 46 which faces away from the flowing exhaust gas 48, outer protective tube 44 protrudes beyond inner protective tube 46. The inside diameter of outer protective tube 44 is preferably so much larger than the outside diameter of inner protective tube 46 that a first flow cross-section results between the two protective tubes 44, 46. The inside diameter of inner protective tube 46 forms a second flow cross-section.

As a result of this geometry, exhaust gas 48 enters the system of the two protective tubes 44, 46 via the first flow cross-section, then changes its direction at the end of protective tubes 44, 46 which faces away from exhaust gas 48, enters inner protective tube 46, and is suctioned out of it by exhaust gas 48 flowing past (arrows denoted by reference numeral 49). A laminar flow results in inner protective tube 46 in the process. This system of protective tubes 44, 46 is attached at or in an exhaust gas tube (not shown), together with soot particle sensor 16, transversely to the flow direction of exhaust gas 48.

Soot particle sensor 16 additionally includes laser 18, which preferably generates parallel laser light 10, as is shown in the present example. The beam splitter, in the form of dichroic mirror 30 already mentioned above by way of example, is situated in the beam path of the parallel laser light 10. A portion of laser light 10 passing through beam splitter 30 without deflection is focused by optical element 20 into the very small spot 22 in the interior of inner protective tube 46. In this spot 22, the light intensity is high enough to heat particles 12 transported together with exhaust gas 48 at the velocity of the flow in the inner protective tube (arrow 49) to several thousand degrees Celsius, so that the heated particles 12 emit significant radiation 14 in the form of thermal radiation.

Radiation 14 is in the near infrared and visible spectral range, for example, however it is not limited to this spectral range.

A portion of this undirected radiation 14 emitted in the form of thermal radiation (“LII light”) is detected by optical element 20, and deflected via beam splitter 30 and directed at detector 26 via lens 31 and filter 32. This configuration has the particularly important advantage that only a single optical access to exhaust gas 48 is required, since the same lens system, in particular, the same optical element 20, including lens 24 is used for the generation of spot 22 and for the detection of thermal radiation 14 originating from particle 12.

In the case of the subject matter of FIG. 4, laser 18 includes a laser diode 50 and a lens 52, which aligns laser light 10 originating from laser diode 50 in parallel. The use of laser diode 50 represents a particularly cost-effective and easy-to-handle option for generating laser light 10. The parallel laser light 10 is focused to form spot 22 by optical element 20.

Particle sensor 16 preferably includes a first part 16.1 exposed to the exhaust gas, and a second part 16.2 not exposed to the exhaust gas, which includes the optical components of particle sensor 16. Both parts are separated by a partition 16.3, which extends between protective tubes 44, 46 and the optical elements of particle sensor 16. Wall 16.3 is used to isolate the sensitive optical elements from the hot, chemically aggressive and “dirty” exhaust gas 48. In partition 16.3, a protective window 54 is provided in the beam path of laser light 10, through which laser light 10 is incident into exhaust gas 48 or flow 49 and via which thermal radiation 14 originating from spot 22 is able to be incident onto optical element 20 and, from there, via beam splitter 30 and filter 32, onto detector 26. It is also possible that particularly sensitive components of the particle sensor, for example the laser and the detector, are accommodated in a separate housing, and that, for example, optical waveguides, for example in the form of one or multiple glass fiber(s), are used for transporting the laser light and/or the thermal radiation to/from the optical components situated at the exhaust gas.

Particle sensor 16 may furthermore include an evaluation unit 56, which is programmed to carry out, based on the signals of the detector 26, an evaluation of the variable which is provided by the detector 26 and characterizes the detected thermal radiation. For this purpose, evaluation unit 56 includes further components which are not shown in greater detail, for example a microprocessor and an electrical memory medium on which a computer program for executing a method explained hereafter is stored.

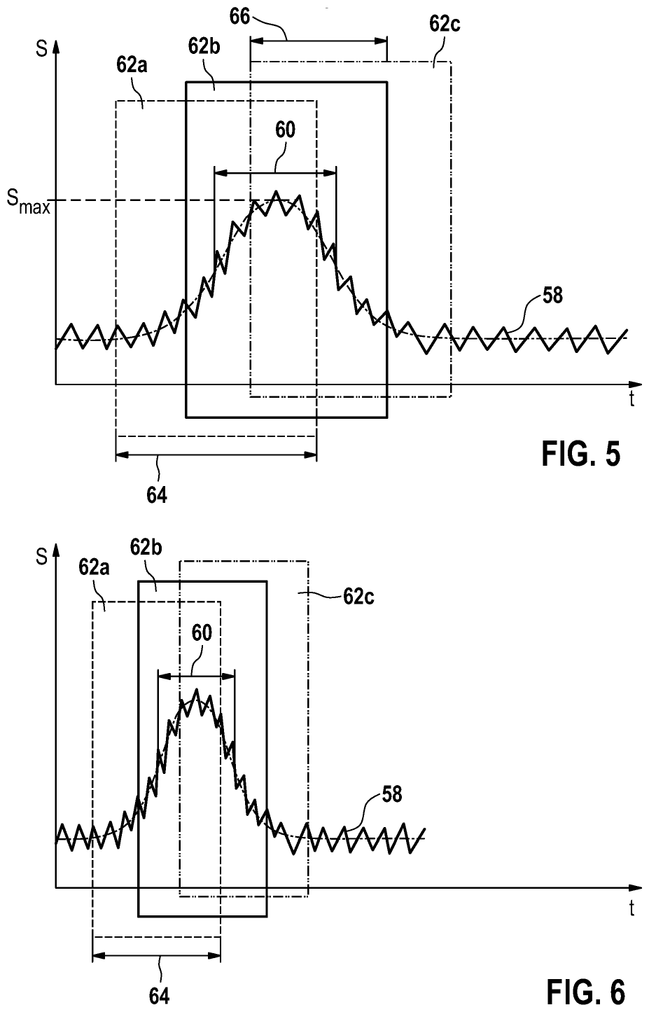

Initially, reference is made to FIGS. 5 and 6. In these, the variable which was already mentioned above and is provided by detector 26 and which characterizes the intensity of thermal radiation 14 detected by detector 26 is plotted against time t. The provided variable, hereafter referred to as “measuring signal,” overall bears reference numeral 58 in the figures. A value of measuring signal 58 is denoted by S. It is apparent that measuring signal 58 is a continuous variable which, however, extends in a wave- or zigzag-shaped manner, which corresponds to noise.

When a particle emits thermal radiation 14, the measuring signal 58, which otherwise remains at a constant low level, increases to an elevated value (maximum Smax) and thereafter drops again. A full width at half maximum (FWHM) is denoted in the figures by a double arrow bearing reference numeral 60. Time intervals, which bear reference numerals 62a, 62b and 62c, are denoted in FIGS. 5 and 6 by rectangular boxes. In the present example, only three time intervals 62a through c are shown by way of example. However, actually an almost unlimited sequence of time intervals exists. A duration 64 of time intervals 62a through c is greater than full width at half maximum 60 in the present example. In the present example, it is approximately 1.5 times full width at half maximum 60.

It is furthermore shown in FIGS. 5 and 6 that time intervals 62a through c overlap. An overlapping time period 66 between consecutive time intervals 62a and 62b or 62b and 62c is constant and, in the present example, is approximately 75% of a duration 64 of a time interval 62a through c, i.e., is greater than half duration 64 of a time interval 62a through c.

Duration 64 of time intervals 62a through c is variable in the present example. It depends on the expected full width at half maximum 60. The expected full width at half maximum 60, in turn, depends on the instantaneous velocity of flow 49 of exhaust gas 48 in spot 22, and thus on the expected possible exposure time of a particle 12 in spot 22. In the application of an internal combustion engine described by way of example in the present example, the velocity of flow 49 of exhaust gas 48 in inner protective tube 46 may, in turn, be ascertained, or at least estimated, based on the instantaneous operating state of the internal combustion engine, for example based on an instantaneous rotational speed and an instantaneous torque, and based on the geometry of outer protective tube 44 and inner protective tube 46.

It is also possible to determine the expected FWHM from the signals of large particles occurring in a temporally adjoining manner, which have a high signal-to-noise (SNR) ratio, and thus are not so much dependent on the method described here.

The dependence of full width at half maximum 60, and thus also of duration 64 of time intervals 62a through c, on the velocity of flow 49 of exhaust gas 48 is such that, at a comparatively low velocity of flow 49 of exhaust gas 48, the expected full width at half maximum 60, and thus also duration 64, is rather large (FIG. 5), whereas the expected full width at half maximum 60, and thus also duration 64, is rather small at a comparatively high velocity of flow 49 of exhaust gas 48 (FIG. 6).

An evaluation of measuring signal 58 always only takes place in each case within a time interval 62a through c. During the evaluation, for example, an integral of measuring signal 58 is formed within the respective time interval 62a through c, i.e., the area beneath measuring signal 58 within the boundaries of the respective time interval 62a through c is calculated. This integral (“integral value”) is thus a variable which is ascertained from the variable which characterizes thermal radiation 14. The integral value obtained for each time interval 62a through c is then compared to a limiting value. A particle 12 is considered to be detected when the integral value reaches or exceeds the limiting value.

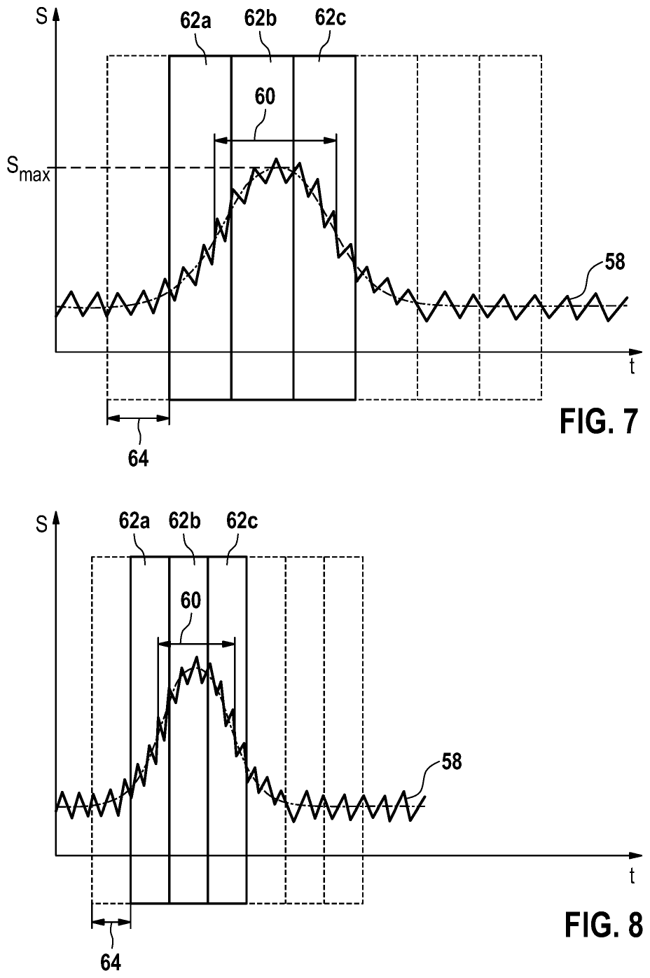

An alternative type of the evaluation is shown in FIGS. 7 and 8. There, no overlapping, but consecutive time intervals 62a through c which directly adjoin one another are used. Again, measuring signal 58 is evaluated by forming the integral beneath measuring signal 58 within each time interval 62a through c. A particle 12 is considered to be detected when the respective integral value reaches or exceeds a limiting value within at least two time intervals directly following one another, in the present example by way of example within three time intervals 62a through c directly following one another. In principle, it is possible in the process that different limiting values may be used for each of the time intervals.

In all above-described methods, the limiting value, which when reached or exceeded allows the presence of a particle 12 to be inferred, may depend on an expected background signal (noise).

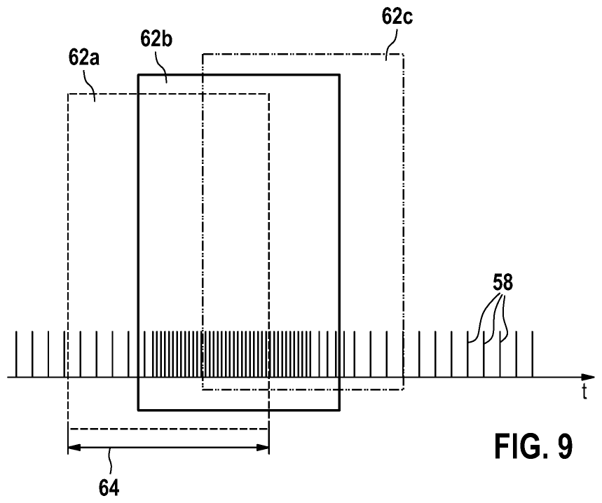

FIGS. 5 through 8 related to one specific embodiment in which detector 26, by way of example, includes a photodiode 26.1 which provides a continuous measuring signal 58. However, it is also possible (FIG. 9) that detector 26 includes an MPCC, which provides a discontinuous measuring signal in the form of a number of individual photon pulses 58. In this case, a particle 12 is considered to be detected when the number of individual photon pulses 58 counted within a time interval 62 reaches or exceeds a limiting value. In the process, the width of the time interval is also adapted as a function of the velocity of the fluid.

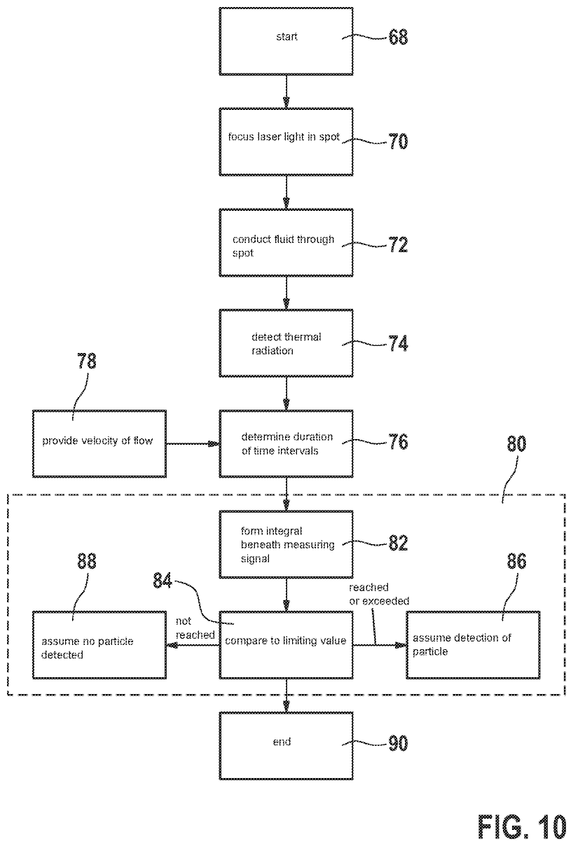

The method for detecting particles 12 described in general terms above is now again explained with reference to FIG. 10: after the start in a block 68, a laser light 10 originating from laser 18 is focused in spot 22 in a block 70. In a block 72, fluid, namely exhaust gas 48, which includes particles 12 is conducted through spot 22 with the aid of flow 49. In a block 74, thermal radiation 14 originating from spot 22 is detected with the aid of detector 26. In a block 76, duration 64 of time intervals 62a through c is determined, and in particular as a function of a velocity of flow 49 of exhaust gas 48 which is provided in a block 78.

As was already mentioned above, detector 26 provides a measuring signal 58, which overall is evaluated in an evaluation block 80 shown in dotted form. Specifically, in a block 82 the integral beneath measuring signal 58 is formed (in the case of a continuous measuring signal 58) in each time interval 62a through c, or the number of individual photon pulses 58 within each time interval 62 is ascertained (in the case of a discontinuous measuring signal 58). In a block 84, the ascertained integrals or ascertained numbers are compared to a limiting value. If the limiting value is reached or exceeded, the detection of a particle 12 is assumed in block 86. If, in contrast, the limiting value is not reached, it is assumed in block 88 that no particle 12 was detected. The method ends in a block 90.

Exhaust gas 48 is only one example of a possible measuring gas. The measuring gas may also be another gas or gas mixture. The method may also be used for other scenarios and usage areas (e.g., with portable emission monitoring systems, measurement of the indoor air quality, emissions of combustion systems (private, industrial)).

In the shown particle sensor, the laser light and/or the thermal radiation may also be entirely or partially conducted with the aid of optical waveguides.

In addition, the use of the method with arbitrary HV corona sensors which are to measure the particle/aerosol concentration in a gas would be possible.

1-14. (canceled)

15. A method for detecting particles or aerosol in a flowing fluid, using laser-induced incandescence, the method comprising the following steps:
a. focusing a laser light originating from a laser in a spot;
b. conducting the fluid which includes particles or aerosol through the spot;
c. detecting a thermal radiation originating from the spot using a detector; and
d. evaluating a variable which is provided by the detector and characterizes the detected thermal radiation within time intervals, a duration of the time intervals being dependent on a velocity of the fluid.

16. The method as recited in claim 15, wherein at least several of the time intervals overlap.

17. The method as recited in claim 16, wherein the duration of the time intervals is greater than an expected full width at half maximum (FWHM) of the variable characterizing the thermal radiation.

18. The method as recited in claim 17, wherein the duration of the time intervals is 1 to 2 times the expected FWHM.

19. The method as recited in claim 18, wherein the duration of the time intervals is 1.5 times the expected FWHM.

20. The method as recited in claim 16, wherein an overlapping time period of the time intervals corresponds to at least half the duration of the time interval.

21. The method as recited in claim 16, wherein a particle is considered to be detected when the variable characterizing the thermal radiation or ascertained from the variable at least reaches one limiting value or multiple different limiting values within a time interval.

22. The method as recited in claim 16, wherein at least several consecutive ones of the time intervals do not overlap.

23. The method as recited in claim 16, wherein at least several consecutive ones of the time intervals do not overlap and directly adjoining one another.

24. The method as recited in claim 22, wherein a particle is considered to be detected when the variable characterizing the thermal radiation or ascertained from the variable at least reaches a limiting value within at least two time intervals directly following one another.

25. The method as recited in claim 21, wherein the limiting value depends on an expected background signal.

26. The method as recited in claim 15, wherein the variable characterizing the thermal radiation is a continuous variable.

27. The method as recited in claim 15, wherein the variable characterizing the thermal radiation is an integral formed from a continuous variable ascertained within a time interval of the time intervals.

28. The method as recited in claim 15, wherein the variable characterizing the thermal radiation is a discontinuous variable formed by pulse-like signals, and a sum of the pulse-like signals is formed within a time interval of the time intervals.

29. The method as recited in claim 15, wherein the velocity of the fluid is ascertained from full width at half maximum (FWHM) of large particles, and the ascertained velocity is then used to determine a length of the time intervals for detection of small particles.

30. An electrical memory medium, for an evaluation unit for use in an exhaust gas system of an internal combustion engine, on which is stored a computer program for detecting particles or aerosol in a flowing fluid, using laser-induced incandescence, the computer program, when executed by the evaluation unit, causing the evaluation unit to perform the following steps:
a. focusing a laser light originating from a laser in a spot;
b. conducting the fluid which includes particles or aerosol through the spot;
c. detecting a thermal radiation originating from the spot using a detector; and
d. evaluating a variable which is provided by the detector and characterizes the detected thermal radiation within time intervals, a duration of the time intervals being dependent on a velocity of the fluid.

31. A state machine in the form of an ASIC, the ASIC being configured to detect particles or aerosol in a flowing fluid, using laser-induced incandescence, the state machine being configured to:
a. focus a laser light originating from a laser in a spot;
b. conduct the fluid which includes particles or aerosol through the spot;
c. detect a thermal radiation originating from the spot using a detector; and
d. evaluate a variable which is provided by the detector and characterizes the detected thermal radiation within time intervals, a duration of the time intervals being dependent on a velocity of the fluid.
